(19) United States
(12) Patent Application Publication
(10) Pub. No.: US 2026/0017707 A1
(43) Pub. Date: Jan. 15, 2026

(54) METHOD, DEVICE, AND STORAGE MEDIUM FOR PRESENTING INFORMATION

(71) Applicant: Beijing Youzhuju Network Technology Co., Ltd., Beijing (CN)

(72) Inventor: Ling Zhu, Beijing (CN)

(21) Appl. No.: 19/020,329

(22) Filed: Jan. 14, 2025

(30) Foreign Application Priority Data
Jul. 12, 2024 (CN) 202410939030.2

(51) Int. Cl. G06Q 30/0601; G06Q 30/0207

(52) U.S. Cl. CPC G06Q 30/0641; G06Q 30/0222

(57) ABSTRACT

Example embodiments of the present disclosure provide a solution for presenting information, and relate to the technical field of computers. The method includes: presenting in a predetermined page an object information set including object information of at least one predetermined object, and presenting a first component in a predetermined page in response to the interactive operation based on the predetermined page satisfying a predetermined condition, where the first component includes resource information of a predetermined virtual resource, the first component is configured for triggering acquisition of the predetermined virtual resource, and the predetermined virtual resource is configured for completing the predetermined interactive event for the predetermined object.

### CROSS-REFERENCE

This application claims priority to Chinese Patent Application No. 202410939030.2, filed on Jul. 12, 2024, and entitled “METHOD, APPARATUS, DEVICE, STORAGE MEDIUM AND PRODUCT FOR PRESENTING INFORMATION”, which is incorporated herein by reference in its entirety.

### FIELD

The embodiments of the present disclosure relate to the technical field of computers, in particular to a method, a device, and a storage medium for presenting information.

### BACKGROUND

With rapid development of information technologies and popularization of mobile Internet, the functions of applications are increasingly richer. In some functions, a virtual resource may be distributed to the user, and the user may complete a corresponding interactive event under the function by using the received virtual resource. Taking the online shopping function as an example, a virtual resource such as a coupon may be distributed to the user, and the user may purchase the commodity under the online shopping function by using the received coupon.

### SUMMARY

The embodiments of the present disclosure provide a method, an apparatus, a device, a storage medium and a product for presenting information, which can optimize an existing information presenting scheme.

In a first aspect, embodiments of the present disclosure provide a method for presenting information. The method includes presenting an object information set in a predetermined page, where the object information set includes object information of at least one predetermined object; and in response to an interactive operation based on the predetermined page satisfying a predetermined condition, presenting a first component in the predetermined page, where the first component includes resource information of a predetermined virtual resource, the first component is configured to trigger acquisition of the predetermined virtual resource, and the predetermined virtual resource is configured to complete a predetermined interactive event for the predetermined object.

In a second aspect, embodiments of the present disclosure further provide an electronic device. The electronic device includes: one or more processors; and a storage device configured to store one or more programs. The one or more programs, when executed by the one or more processors, cause the one or more processors to perform acts comprising presenting an object information set in a predetermined page, where the object information set includes object information of at least one predetermined object; and in response to an interactive operation based on the predetermined page satisfying a predetermined condition, presenting a first component in the predetermined page, where the first component includes resource information of a predetermined virtual resource, the first component is configured to trigger acquisition of the predetermined virtual resource, and the predetermined virtual resource is configured to complete a predetermined interactive event for the predetermined object.

In a third aspect, embodiments of the present disclosure further provide a non-transitory computer storage medium including computer-executable instructions, where the computer-executable instructions, when executed by a computer processor, cause the computer processor to perform acts of the method for presenting information provided in the embodiments of the present disclosure.

In a fourth aspect, embodiments of the present disclosure further provide a computer program product, including a computer program, where the computer program, when executed by a processor, cause the processor to perform acts of the method for presenting information provided in the embodiments of the present disclosure.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers represent the same or similar elements. It should be understood that the drawings are schematic, and elements and elements are not necessarily drawn to scale.

FIG. 1 is a schematic flowchart of a method for presenting information according to an embodiment of the present disclosure.

FIG. 2 is a schematic diagram of interface interaction according to an embodiment of the present disclosure.

FIG. 3 is a schematic diagram of another interface interaction according to an embodiment of the present disclosure.

FIG. 4 is a schematic flowchart of a further method for presenting information according to an embodiment of the present disclosure.

FIG. 5 is a schematic diagram of still another interface interaction according to an embodiment of the present disclosure.

FIG. 6 is a schematic structural diagram of an apparatus for presenting information according to an embodiment of the present disclosure.

FIG. 7 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, but rather the embodiments are provided for a more thorough and complete understanding of the present disclosure. It should be understood that the drawings and embodiments of the present disclosure are provided for the purposes of example only and are not intended to limit the scope of the present disclosure.

It should be understood that the steps recited in the method embodiments of the present disclosure may be performed in different orders, and/or in parallel. Further, the method embodiments may include additional steps and/or the illustrated steps may be omitted. The scope of the present disclosure is not limited in this respect.

As used herein, the term “comprising” and variations thereof are exclusive, i.e., “including but not limited to”. The term “based on” is “based at least in part on”. The term “one embodiment” means “at least one embodiment”; the term “another embodiment” means “at least one another embodiment”; the term “some embodiments” means “at least some embodiments”. The relevant definitions of other terms will be given below.

It should be noted that the concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative but not limiting, and those skilled in the art will appreciate that these modifications shall be understood as “one or more” unless the context clearly indicates otherwise.

The names of messages or information exchanged between a plurality of devices in embodiments of the present disclosure are for illustrative purposes only and are not intended to limit the scope of such messages or information.

It can be understood that, before the technical solutions disclosed in the embodiments of the present disclosure are used, the types, the usage scope, the usage scenario and the like of personal information related to the present disclosure, should be notified to the user in an appropriate manner according to the relevant laws and regulations, and the authorization of the user is acquired.

For example, in response to receiving an active request from a user, prompt information is sent to the user to explicitly prompt the user that the requested operation will need to acquire and use the personal information of the user. Therefore, Thus, the user can autonomously select whether to provide personal information to software or hardware such as electronic devices, applications, servers, or storage media that perform operations of the disclosed technical solution, based on the prompt message.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It may be understood that the above notification and user authorization process are only illustrative which do not limit the implementation of this disclosure. Other methods that meet relevant laws and regulations can also be applied to the implementation of this disclosure.

It may be understood that the data involved in the technical solution (including but not limited to the data itself, the acquisition or use of the data) should follow the requirements of the corresponding laws and regulations and related provisions.

FIG. 1 is a schematic flowchart of a method for presenting information provided by an embodiment of the present disclosure. The embodiments of the present disclosure are applicable to a case in which presenting of virtual resource related information is flexibly performed in a process of presenting an object information set. The method may be performed by an apparatus for presenting information. The apparatus may be implemented in a form of software and/or hardware, and optionally, implemented by an electronic device which may be a mobile terminal such as a mobile phone, a smart watch, a tablet computer, and a personal digital assistant, or may be a device such as a personal computer (PC) terminal or a server.

As shown in FIG. 1, the method includes steps 101-102.

At step 101, an object information set is presented in a predetermined page, where the object information set includes object information of at least one predetermined object.

The page in the embodiments of the present disclosure may be an application page or a web page corresponding to a predetermined client. For example, the predetermined page is a page in the predetermined client used to present object information, in the predetermined page, object information of one or more predetermined objects may be presented, each predetermined object corresponds to one piece of object information, and the one or more pieces of object information may be presented in a centralized manner in a form of an object information set. In some embodiments, the predetermined page may include a service aggregation page, a predetermined subject page, a search result page, or the like. In the service aggregation page, an object information set and a service function entry may be presented, where the service aggregation page may be, for example, a homepage for a mall, and the service function entry may include, for example, an order viewing entry, a customer service message viewing entry, and an focusing store list viewing entry. The predetermined subject is a subject providing a predetermined object, such as a store, and the predetermined subject page may include, for example, a store page. The search result page may present an object information set and a search component (for example, a search box), where search information may be presented in the search component object (for example, a search keyword), and the search result page may also present a search result screening item.

For example, the predetermined object may include an object that can be acquired using an Internet platform (including a server corresponding to a predetermined client), such as a commodity, an item, a service, or information. The object information may include object attribute information and/or image resource information of the predetermined object, and may further include other information related to the predetermined object. The object attribute information may include, for example, an object identifier (for example, a commodity name), an object acquiring cost (for example, a commodity price), an object inventory (for example, whether there is a commodity or a remaining quantity, etc.), an object characteristic (for example, a commodity selling point), a brand, a model, material or component, and the like. Image resource information may include information of resources such as an image and/or a video associated with the predetermined object, such as a commodity schematic diagram (for example, a commodity picture) or a commodity explanation video (for example, a live playback video of a commodity). A specific presenting manner of each piece of object information in the object information set is not limited, and it may be presented in a form of a list or a matrix, for example, it may be a commodity list.

At step 102, in response to an interactive operation based on the predetermined page satisfying a predetermined condition, a first component is presented in the predetermined page, where the first component includes resource information of a predetermined virtual resource, the first component is configured to trigger acquisition of the predetermined virtual resource, and the predetermined virtual resource is configured to complete a predetermined interactive event for the predetermined object.

For example, the user may complete the predetermined interactive event for the predetermined object through the predetermined client, and the predetermined interactive event may include, for example, purchasing a commodity, watching a video or a live streaming, and the like. The server corresponding to the predetermined client may distribute a virtual resource to the user, so that the user uses the virtual resource in the process of completing the predetermined interactive event, such as, the virtual resource may be a coupon or a watching duration coupon.

In the related art, a user is required to acquire a virtual resource by triggering an acquiring operation for the virtual resource on a specified page, such as a coupon center page, or a coupon page located on the upper level of a commodity detail page that is popped up after triggering a coupon entry on the product detail page, etc. The operation path for acquiring the virtual resource is long and inefficient, and the user is likely to forget to collect coupons, thus missing the opportunities to use the virtual resources.

In the embodiments of the present disclosure, during the process when the user views the predetermined page, the user may input various interactive operations based on the predetermined page, and the interactive operation may include an operation for the object information set, an operation for the object information, and other operations (such as a search operation). For example, a condition (denoted as a predetermined condition) to be satisfied by the interactive operation based on the predetermined page when triggering the display of the first component may be set in advance based on the presenting requirements of the predetermined virtual resources. In the process of presenting the object information set in the predetermined page, whether the received interactive operation based on the predetermined page input satisfies the predetermined condition may be detected in real time. If the predetermined condition is satisfied, the first component is presented in the predetermined page.

As an example, the presenting position and the presenting style of the first component in the predetermined page are not limited, for example, the presenting position may be a top, a bottom, or a center position of the predetermined page, or may be an adjacent position of the presenting area where the object information set is located, or between two pieces of object information, etc., and the presenting style may be a card or a floating frame. The first component includes resource information of a predetermined virtual resource. The predetermined virtual resource is a virtual resource that can be acquired by triggering the first component, and the predetermined virtual resource may be used in the process of completing a predetermined interactive event for a predetermined object to which any object information in the object information set belongs. The resource information may include, for example, a resource type, a resource name or a quantity of resources, and the like, for example, the resource information may include a coupon type, a coupon name, a coupon amount, and the like.

In some embodiments, there may be one or more predetermined virtual resources. If there are a plurality of predetermined virtual resources, each of the plurality of predetermined virtual resources may be corresponding to one piece of resource information, and each of the plurality of predetermined virtual resources may be corresponding to one respective first component or the same first component. If the plurality of predetermined virtual resources are corresponding to the same first component, when the first component is triggered, the plurality of predetermined virtual resources may be acquired in batches. The number of the first components may be the same as the number of the predetermined virtual resources, or the number of the first components is 1.

In some embodiments, the first component further includes a first control, and the first component is configured to trigger acquisition of the predetermined virtual resource. If there are a plurality of predetermined virtual resources, the first component may be one, each predetermined virtual resource in the plurality of predetermined virtual resources may be corresponding to one piece of resource information included in the first component, and each of the plurality of predetermined virtual resources may be corresponding to one respective first control or to the same first control. If the plurality of predetermined virtual resources are corresponding to the same first control, when the first control is triggered, the plurality of predetermined virtual resources may be acquired in batches.

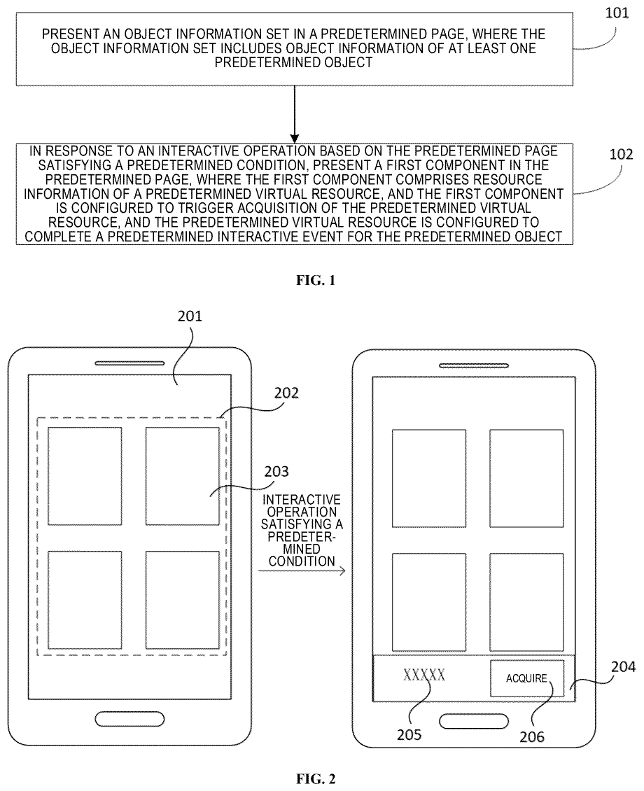

FIG. 2 is a schematic diagram of an interface interaction according to an embodiment of the present disclosure. As shown in FIG. 2, an object information set 202 is presented in a predetermined page 201. The object information set 202 includes object information 203 of the at least one predetermined object (four predetermined objects are shown as an example, and the specific number for the predetermined objects is not limited). If interactive operation input by the user based on the predetermined page 201 satisfies the predetermined condition, a first component 204 is presented in the predetermined page 201. As an example, the first component 204 in FIG. 2 is presented at the bottom of the predetermined page 201. The first component 204 includes the resource information 205 of the predetermined virtual resource and the first control 206, and the first control 206 is configured to trigger acquisition of the predetermined virtual resource.

According to the method for presenting information provided by the embodiments of the present disclosure, the object information set including the object information of the at least one predetermined object is presented in the predetermined page, the first component is presented in the predetermined page in response to the interactive operation based on the predetermined page satisfying the predetermined condition, the first component includes the resource information of the predetermined virtual resource, the first component is configured for triggering acquisition of the predetermined virtual resource, and the predetermined virtual resource is configured for completing the predetermined interactive event for the predetermined object. By adopting the present solution, the first component can be flexibly presented in the process of presenting the object information set, the flexibility of information presenting is improved, and the virtual resource acquisition efficiency and the completion rate of the predetermined interactive event are improved.

In some embodiments, presenting the first component in the predetermined page includes: if there is a predetermined virtual resource to be acquired, presenting the first component in the predetermined page. Therefore, the presenting of the first component can be more flexibly controlled.

As an example, if the interactive operation based on the predetermined page satisfies a predetermined condition, it is determined whether there is a predetermined virtual resource to be acquired. Specifically, it can be determined whether there is a predetermined virtual resource that can be acquired by the current user, and if there is a predetermined virtual resource that can be acquired by the current user, the existing predetermined virtual resource is determined as the predetermined virtual resource to be acquired. It can be further determined whether there is a predetermined virtual resource suitable for the predetermined object related to the object information in the object information set. If there is such a predetermined virtual resource, the current predetermined virtual resource is determined as the predetermined virtual resource to be acquired. Alternatively, both the determination on whether there is a predetermined virtual resource to be acquired by the current user and the determination on whether there is a predetermined virtual resource suitable for the predetermined object related to the object information in the object information set are made, and if both the results of the two determinations are positive, an intersection of the predetermined virtual resources is determined as the predetermined virtual resource to be acquired. If there is no predetermined virtual resource to be acquired, the first component may not be presented.

In some embodiments, presenting the first component in the predetermined page in response to the interactive operation based on the predetermined page satisfying a predetermined condition includes: in response to a predetermined trigger for object information of a target predetermined object, presenting a target page; in response to a page return operation based on the target page, presenting the predetermined page, and presenting the first component in the predetermined page, where the target page is configured to present object detail information of the target predetermined object, where the target predetermined object is one of the at least one predetermined object. In this way, after the user inputs a predetermined trigger for a certain object information in the object information set to enter the target page to view the object detail information, the predetermined page is returned to, and the first component is presented, so that the flexibility of presenting of the first component is further improved, and the virtual resource acquisition efficiency and the completion rate of the predetermined interactive event can be improved.

For example, the predetermined trigger may be, for example, a click operation, and the target predetermined object is a predetermined object related to the object information clicked by the user. The object detail information of the target predetermined object may be presented in the target page, and the object detail information may include, for example, information regarding the detailed introduction of the predetermined object, such as a multi-angle image or a video of a commodity, an instruction for use of a commodity, an ingredient list, or an expiration date, and the like. When the user enters the target page to view the object detail information by inputting the predetermined trigger, there may be a need to complete the predetermined interactive event for the predetermined object, and after the page return operation is input in a manner of triggering a page return control, the first component is presented in the predetermined page returned and presented, thereby improving the convenience of acquiring the predetermined virtual resource by the user.

In some embodiments, presenting the predetermined page and presenting the first component in the predetermined page includes: presenting the predetermined page, and presenting the first component in an area adjacent to a presenting area of the predetermined page where the object information of the target predetermined object is located. Therefore, the user can quickly locate the position where the first component is located, and the acquisition efficiency of the predetermined virtual resource is further improved.

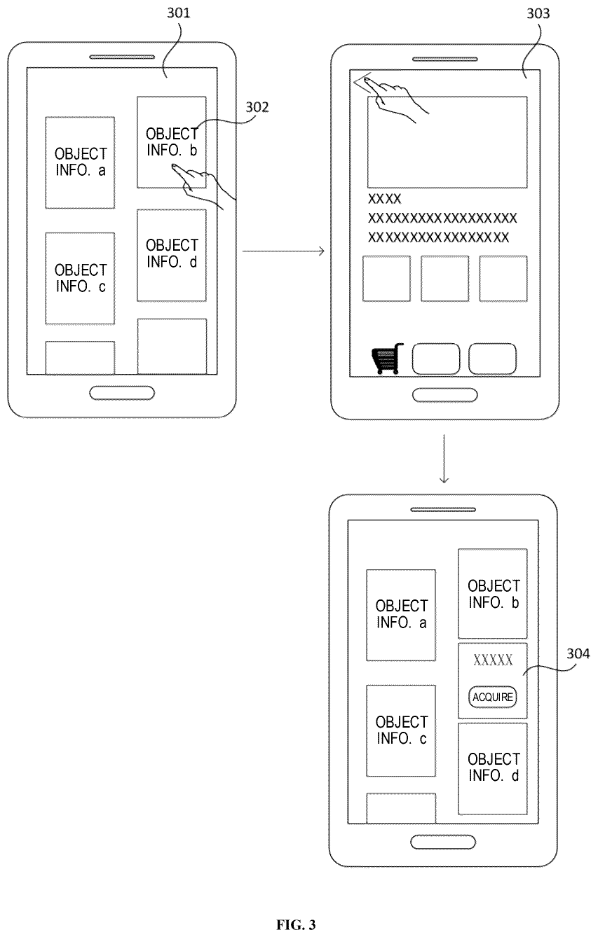

FIG. 3 is a schematic diagram of another interface interaction according to an embodiment of the present disclosure. As shown in FIG. 3, an object information set is presented in a predetermined page 301. After the user clicks the object information 302 (object information b) of the target predetermined object, the presenting of the predetermined page 301 is switched to presenting of the target page 303, and the object detail information of the target predetermined object is presented in the target page 303. After the user clicks a page return control in the target page 303, the presenting of the target page 303 is switched back to the presenting of the predetermined page 301, and the first component 304 is presented in the area adjacent to the presenting area of the predetermined page 301 where the object information of the target predetermined object is located. In some embodiments, the presenting area of the object information adjacent to the object information of the target predetermined object is adjusted, so that the first component can be presented. As shown in FIG. 3, the presenting area of the object information dis moved downward, so that the first component 304 is presented between the object information b and the object information d.

In some embodiments, presenting the first component in the predetermined page in response to the interactive operation based on the predetermined page satisfying the predetermined condition includes: in response to an accumulated number of pieces of object information presented in the predetermined page responding to the interactive operation for the object information set being greater than or equal to a predetermined number threshold, presenting the first component in the predetermined page. Therefore, after the number of pieces of the object information viewed by the user in the predetermined page reaches the threshold, the first component is presented. The presenting flexibility of the first component is further improved, and the virtual resource acquisition efficiency and the completion rate of the predetermined interactive event can be improved.

For example, the interactive operation for the object information set may be a browsing operation for the object information, for example, it may be a sliding operation, under an action of a sliding operation input by the user (possibly being input for one or more times), more pieces of object information may be displayed in the predetermined page. When the number of pieces of accumulated presented object information is greater than or equal to the predetermined number threshold (which may be set according to the actual requirement, for example, 10), there may be a requirement of completing the predetermined interactive event for the predetermined object, and then the first component is presented, so that the convenience of acquiring the predetermined virtual resource by the user is improved.

In some embodiments, presenting the first component in the predetermined page in response to the interactive operation based on the predetermined page satisfying the predetermined condition includes: in response to a number of times of a search operation triggered based on the predetermined page being greater than or equal to a predetermined times threshold, presenting the first component in the predetermined page, where a search result of the search operation includes the object information set. Therefore, after the user inputs the search operation in the predetermined page for a plurality of times, the first component is presented, the presenting flexibility for the first component is further improved, and the virtual resource acquisition efficiency and the completion rate of the predetermined interactive event can be improved.

For example, the predetermined page may be a search result page, and a search component may be further presented while presenting the object information set, and the user may trigger the search operation through the search component, for example, input object search information through the search box, and click the search control, so as to implement search of the predetermined object. If the user inputs the search operation for a plurality of times, there may be a need to search for the predetermined object that needs to be acquired, then the first component is presented, and the convenience of acquiring the predetermined virtual resource by the user is improved.

In some embodiments, presenting the first component in the predetermined page in response to the interactive operation based on the predetermined page satisfying the predetermined condition includes at least two of the above, so that the first component can be presented under different conditions, thereby improving the probability of presenting the first component, and further improving the acquisition efficiency of the predetermined virtual resource.

In some embodiments, the method further includes after presenting the first component in the predetermined page: in response to a trigger for the first control, canceling presenting of the first component, and presenting a second component in the predetermined page, where the second component includes predetermined prompt information configured to prompt to use of the predetermined virtual resource. Therefore, after the user triggers the first component acquisition of the predetermined virtual resource, the presenting of the first component is canceled, so as to reduce the occupation of the page space by the first component or the occlusion of the page content, and the second component is presented, so that the user is prompted to use the acquired predetermined virtual resource through the predetermined prompt information included in the second component.

In some embodiments, the first component includes a first control configured to trigger acquisition of the predetermined virtual resource. In response to a trigger for the first component, cancelling the presenting of the first component includes: canceling the presenting of the first component in response to a trigger for the first control.

In some embodiments, in response to a trigger for the first control, a presenting state of the first control is changed (for example, a background color of the control and/or a control text is changed), and the presenting of the first component is canceled, and a second component is presented in the predetermined page.

In some embodiments, the second component satisfies at least one of the following: the second component being a floating component; a presenting size of the second component being smaller than a presenting size of the first component; or a presenting position of the second component being different from a presenting position of the first component. Therefore, the presenting effect of the second component can be improved.

For example, the second component is a floating component, and during the process of a user browsing the object information in the object information set (for example, after receiving the interactive operation for the object information set, specifically, after receiving the sliding operation for the object information set), the floating presenting of the second component may be maintained, thereby improving the prompt effect of the predetermined prompt information. In some embodiments, the second component may include a close control, and in response to a trigger for the close control, the presenting of the second component is canceled. Therefore, the user is enabled to actively close the second component, and the blocking of the page content in the predetermined page by the second component is reduced.

For example, the presenting size of the second component is smaller than the presenting size of the first component, and after the presenting of the first component is canceled, the occupation of the page space or the shielding of the page content by the first component can be reduced. As compared with the presenting of the first component, the presenting size of the second component. Therefore, as compared with the presenting of the first component, the occupation of the page space or the shielding of the page content can be reduced to a certain extent.

For example, the presenting position of the second component is different from the presenting position of the first component, so that the user can quickly view the change of the component, thereby quickly positioning the predetermined prompt information, and improving the prompt effect. In some embodiments, the first component is presented in an area adjacent to a presenting area of the predetermined page where the object information of the target predetermined object is located, the second component is presented at a predetermined position at a page edge of the predetermined page, and a distance between the predetermined position and the page edge is less than or equal to a predetermined distance threshold.

In some embodiments, the predetermined prompt information includes a second control; after presenting the second component in the predetermined page, the method further includes: in response to a trigger for the second control, presenting resource detail information of the predetermined virtual resource. Therefore, the resource detail information of the predetermined virtual resource can be viewed in a manner of triggering the control, and the operation efficiency is improved.

In some embodiments, the resource detail information may include, for example, a resource name, a resource type, and a resource amount of the predetermined virtual resource, or may include a usage condition or a use period. In some embodiments, in response to a trigger for the second control, a resource detail page is presented, and resource detail information of the predetermined virtual resource is presented in a resource detail page. For example, the resource detail page may be located on an upper layer of the predetermined page, and a presenting size of the resource detail page is less than a display size of the presenting page.

In some embodiments, changing the presenting state of the first control may include modifying control text in the first control to control text of the second control, for example, modifying the control text in the first control from “acquire” to “use”.

In some embodiments, before presenting the object information set in the predetermined page, the method further includes: acquiring object search information, where presenting the object information set in the predetermined page includes: in response to a search operation triggered for the object search information, presenting the object information set in the predetermined page, where the at least one predetermined object is associated with the object search information. Therefore, in the process of presenting the object information of the predetermined object as the search result after the user actively triggers the search operation, the first component is presented, the acquisition efficiency of the predetermined virtual resource is improved in the object search scene, and then the completion rate of completing the predetermined interactive event for the searched predetermined object is improved.

For example, the object search information may be understood as information that is searched for the predetermined object, it may be input by the current user, or may be automatically determined by the predetermined client. The object search information may specifically be a search keyword used to represent a feature (for example, an attribute or a category) of the predetermined object. For example, the user may input object search information based on a search page (which may include a predetermined page). For example, the search page may include a search box, and after the user triggers the search box, the user may input the object search information. The search page may specifically be a page in a predetermined client providing an object search function, and the object search function may be integrated in a page such as a shopping mall homepage or a search result page. The at least one predetermined object is associated with the object search information, and the search result corresponding to the object search information includes the object information set.

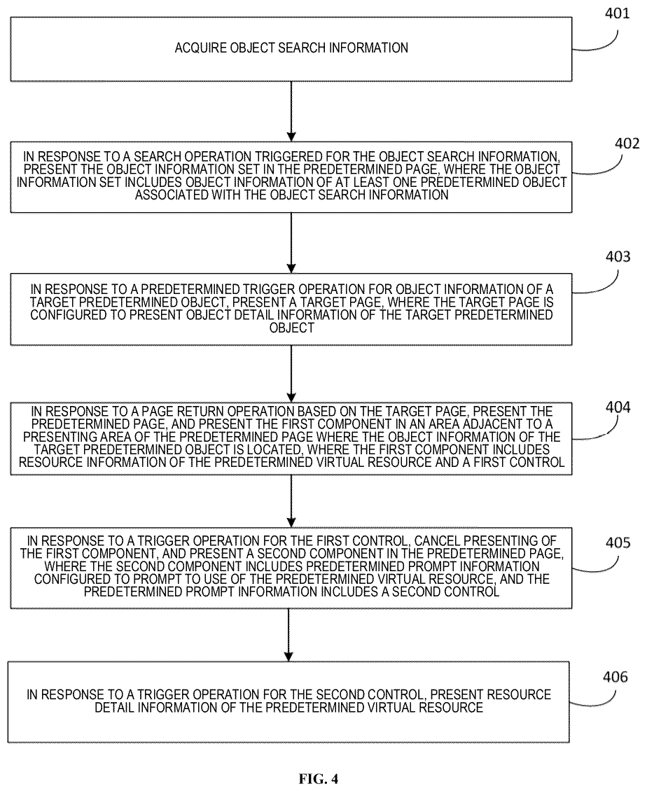

FIG. 4 is a schematic flowchart of a further method for presenting information according to an embodiment of the present disclosure.

At step 401, object search information is acquired.

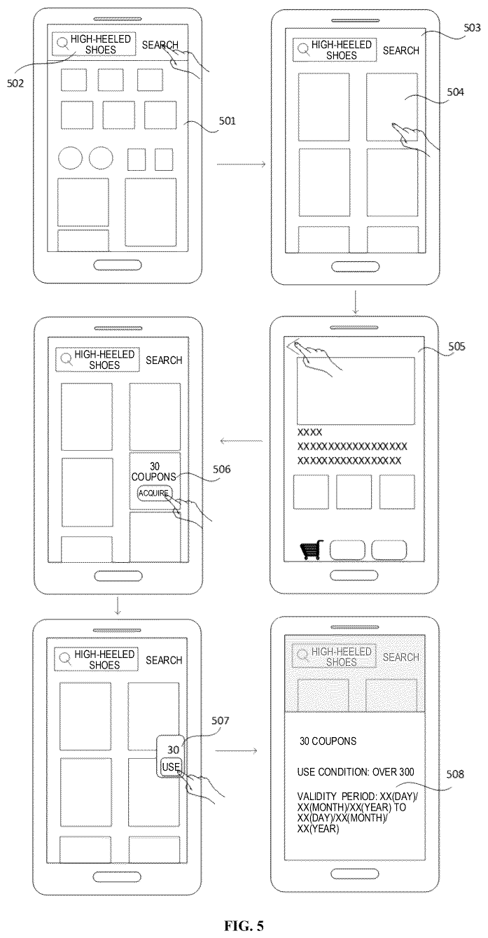

FIG. 5 is another schematic diagram of interface interaction according to an embodiment of the present disclosure, as shown in FIG. 5, if a user inputs object search information 502, such as “high-heeled shoes”, in a search box in a search page 501 (for example, a shopping mall homepage), then the object search information may be acquired.

At step 402, the object information set is presented in a predetermined page in response to a search operation triggered for the object search information, where the object information set includes object information of at least one predetermined object associated with the object search information.

As shown in FIG. 5, the user may trigger a search operation for the object search information by clicking a search control, and a predetermined page 503 (for example, a search result page) is presented. In some embodiments, the search page may also be a predetermined page. The object information set is presented in the predetermined page 503, and the object information set includes object information of a plurality of predetermined objects associated with “high-heeled shoes”, such as commodity information of high-heeled shoes of different brands.

At step 403, a target page is presented in response to a predetermined trigger for the object information of the target predetermined object, where the target page is configured to present object detail information of the target predetermined object.

As shown in FIG. 5, after the user clicks the object information 504 of the target predetermined object, the target page 505 is presented. The target page 505 is configured to present object detail information of the target predetermined object. The object detail information may include a preview image such as a commodity main image, commodity description information, and/or different commodity specifications. The target page 505 may also be configured to present a add-to-cart control and other related controls.

At step 404, a predetermined page is presented in response to a page return operation based on the target page, and the first component is presented in an area adjacent to a presenting area of the predetermined page where the object information of the target predetermined object is located, where the first component includes resource information of the predetermined virtual resource and the first control.

As shown in FIG. 5, after the user clicks the page return control in the target page 505, the presenting of the target page 505 is switched back to the presenting of the predetermined page 503, and the first component 506 is presented in the adjacent area below the presenting area of the predetermined page 503 where the object information of the target predetermined object is located. The first component 506 includes resource information of a predetermined virtual resource, such as “30 coupons” in the figure, and the first component 506 further includes a first control, such as the “acquire” control in FIG. 5.

At step 405, the presenting of the first component is cancelled in response to the trigger for the first control, and a second component is presented in the predetermined page, where the second component includes predetermined prompt information configured to prompt use of the predetermined virtual resource, and the second control is included in the predetermined prompt information.

As shown in FIG. 5, after the user clicks on the first control, the presenting of the first component 506 is canceled, and the second component 507 is presented in the predetermined page 503, where the second component 507 is a floating component and is presented in a floating frame style, and it is presented at an edge position on the right side of the predetermined page 503, and the presenting size of the second component 507 is smaller than the presenting size of the first component 506.

At Step 406, resource detail information of a predetermined virtual resource is presented in response to a trigger for the second control.

As shown in FIG. 5, after the user clicks the second control in the second component 507, the resource detail information 508 of the predetermined virtual resource is presented on the upper layer of the predetermined page 503, and the resource detail information may include the resource name “30 coupons”, “use condition: over 300”, and “validity period: xx(Day)/xx(Month)/xxxx(Year) to xx(Day)/xx(Month)/xxxx(Year)”.

According to the method for presenting information provided by the embodiments of the present disclosure, after the user actively triggers the search operation, the object information set of the predetermined object is presented as the search result; after the user triggers the object information of the target predetermined object therein to enter the target page for presenting the object detail information, and then the predetermined page is returned to, the first component can be presented in an area adjacent to the presenting area where the object information of the triggered target predetermined object is located, so that the user can conveniently view the available resource information of the predetermined virtual resource and conveniently acquire the predetermined virtual resource in a way of triggering the first control, after the acquisition is successful, the presenting of the first component is canceled and the second component is presented, so that the user can be prompted to complete the predetermined interactive event for the predetermined object by using the acquired predetermined virtual resource, and the resource detail information can be viewed through triggering the second control in the second component. Thus the flexibility of presenting information can be effectively improved, and the virtual resource acquisition efficiency and the completion rate of the predetermined interactive event can be improved.

FIG. 6 is a schematic structural diagram of an apparatus for presenting information according to an embodiment of the present disclosure. The apparatus includes an information set presenting module 601 configured to present an object information set in a predetermined page, where the object information set includes object information of at least one predetermined object. The apparatus further includes a first component presenting module 602 configured to present, in response to an interactive operation based on the predetermined page satisfying a predetermined condition, a first component in the predetermined page, where the first component includes resource information of a predetermined virtual resource, the first component is configured to trigger acquisition of the predetermined virtual resource, and the predetermined virtual resource is configured to complete a predetermined interactive event for the predetermined object.

According to the apparatus for presenting information provided by the embodiments of the present disclosure, the first component can be flexibly presented during when the object information set is presented, the flexibility of presenting information is improved, and the virtual resource acquisition efficiency and the completion rate of the predetermined interactive event is improved.

In some embodiments, presenting the first component in the predetermined page in response to the interactive operation based on the predetermined page satisfying the predetermined condition includes at least one of the following: in response to a predetermined trigger for object information of a target predetermined object, presenting a target page, in response to a page return operation based on the target page, presenting the predetermined page, and presenting the first component in the predetermined page, where the target page is configured to present object detail information of the target predetermined object, and the target predetermined object is one of the at least one predetermined object; and in response to an accumulated number of pieces of object information presented in the predetermined page responding to the interactive operation for the object information set being greater than or equal to a predetermined number threshold, presenting the first component in the predetermined page; in response to a number of times of a search operation triggered based on the predetermined page being greater than or equal to a predetermined times threshold, presenting the first component in the predetermined page, where a search result of the search operation includes the object information set.

In some embodiments, presenting the predetermined page and presenting the first component in the predetermined page includes: presenting the predetermined page, and presenting the first component in an area adjacent to a presenting area of the predetermined page where the object information of the target predetermined object is located.

In some embodiments, presenting the first component in the predetermined page includes: in response to existence of a predetermined virtual resource to be acquired, presenting the first component in the predetermined page.

In some embodiments, the apparatus further includes: a second component presenting module configured to, after presenting the first component in the predetermined page, cancel presenting of the first component in response to a trigger for the first component, and present a second component in the predetermined page, where the second component includes predetermined prompt information configured to prompt to use of the predetermined virtual resource.

In some embodiments, the first component further includes a first control, and the first component is configured to trigger acquisition of the predetermined virtual resource. Canceling the presenting of the first component in response to a trigger for the first component includes: canceling the presenting of the first component in response to a trigger for the first control.

In some embodiments, the predetermined prompt information includes a second control; and the apparatus further includes: a resource detail presenting module configured to present, after presenting the second component in the predetermined page and in response to a trigger for the second control, resource detail information of the predetermined virtual resource. In some embodiments, the second component satisfies at least one of the following: the second component being a floating component; a presenting size of the second component being smaller than a presenting size of the first component; and a presenting position of the second component being different from a presenting position of the first component.

In some embodiments, the apparatus further includes: a search information acquiring module configured to acquire object search information before presenting the object information set in a predetermined page; an information set presenting module configured to present, in response to a search operation triggered for the object search information, presenting the object information set in the predetermined page, where the at least one predetermined object is associated with the object search information.

The apparatus for presenting information provided in the embodiments of the present disclosure may perform the method for presenting information provided by any embodiments of the present disclosure, and has corresponding functional modules and beneficial effects when performing the method.

It should be noted that the units and modules included in the foregoing apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

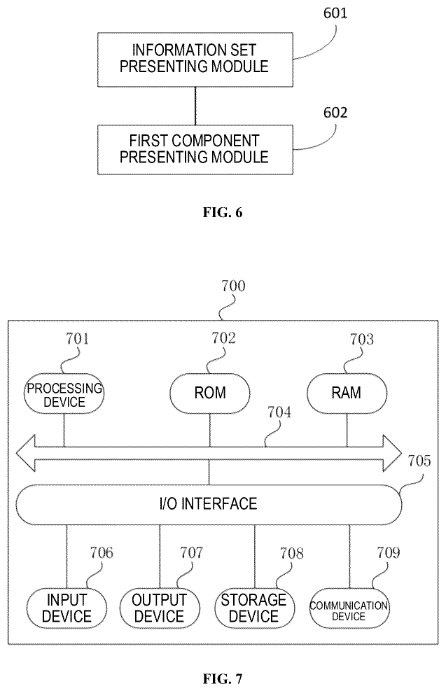

FIG. 7 is a schematic structural diagram of an electronic device according to an embodiment of the present disclosure. FIG. 7 is a schematic structural diagram of an electronic device 700 (such as the terminal device or server in FIG. 7) suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 7 is merely an example, and should not impose any limitation on the functions and scope of use of the embodiments of the present disclosure.

As shown in FIG. 7, the electronic device 700 may include a processing device (for example, a central processing unit, a graphics processor, etc.) 701, which may perform various appropriate actions and processes according to a program stored in a read-only memory (ROM) 702 or a program loaded into a random access memory (RAM) 703 from a storage device 708. In the RAM 703, various programs and data required by the operation of the electronic device 700 are also stored. The processing device 701, the ROM 702, and the RAM 703 are connected to each other through a bus 704. An edit/output (I/O) interface 705 is also connected to the bus 704.

Generally, the following devices may be connected to the I/O interface 705: an input device 706 including, for example, a touch screen, a touchpad, a keyboard, a mouse, a camera, a microphone, an accelerometer, a gyroscope, etc.; an output device 707 including, for example, a liquid crystal display (LCD), a speaker, a vibrator, etc.; a storage device 708 including, for example, a magnetic tape, a hard disk, etc.; and a communication device 709. The communication device 709 may enable the electronic device 700 to communicate wirelessly or wired with other devices to exchange data. While FIG. 7 illustrates the electronic device 700 as being equipped with various devices, it should be understood that it is not required to implement or have all the illustrated devices. More or fewer devices may alternatively be implemented or provided.

In particular, according to the embodiments of the present disclosure, the process described above with reference to the flowchart may be implemented as a computer software program. For example, embodiments of the present disclosure include a computer program product including a computer program embodied on a non-transitory computer readable medium, the computer program including a program code for performing the method shown in the flowchart. In such embodiments, the computer program may be downloaded and installed from the network through the communication device 709, or installed from the storage device 708, or from the ROM 702. When the computer program is executed by the processing device 701, the foregoing functions defined in the method of the embodiments of the present disclosure are performed.

The names of messages or information exchanged between a plurality of devices in embodiments of the present disclosure are for illustrative purposes only and are not intended to limit the scope of such messages or information.

The electronic device provided by the embodiments of the present disclosure and the method for presenting information provided in the foregoing embodiments belong to the same inventive concept, and technical details not described in detail in this embodiment may refer to the foregoing embodiments, and this embodiment has the same beneficial effects as the foregoing embodiments.

Embodiments of the present disclosure provide a computer storage medium, on which a computer program is stored, and when the program is executed by a processor, the method for presenting information provided in the foregoing embodiments is implemented.

Embodiments of the present disclosure provide a computer program product, including a computer program, where when the program is executed by a processor, the method for presenting information provided in the foregoing embodiments is implemented.

It should be noted that the computer-readable medium described above may be a computer readable signal medium, a computer readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of computer-readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

The computer-readable medium described above may be included in the electronic device; or may be separately present without being assembled into the electronic device.

The computer readable medium carries one or more programs, and when the one or more programs are executed by the electronic device, the electronic device is caused to: present an object information set in a predetermined page, where the object information set includes object information of at least one predetermined object; and in response to an interactive operation based on the predetermined page satisfying a predetermined condition, present a first component in the predetermined page, where the first component includes resource information of a predetermined virtual resource, the first component is configured to trigger acquisition of the predetermined virtual resource, and the predetermined virtual resource is configured to complete a predetermined interactive event for the predetermined object.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may be executed entirely on a user computer, partially executed on a user computer, as a stand-alone software package, partially on a user computer, partially on a remote computer, or entirely on a remote computer or server. In the case of involving a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units involved in the embodiments of the present disclosure may be implemented in software, or may be implemented in hardware. For example, the information set presenting module may also be described as “module for presenting the object information set in the predetermined page”.

The functions described above may be performed, at least in part, by one or more hardware logic components. For example, without limitation, example types of hardware logic components that may be used include Field Programmable Gate Arrays (FPGAs), Application Specific Integrated Circuits (ASICs), Application Specific Standard Products (ASSPs), System-On-a-Chip (SOCs), Complex Programmable Logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

The above description is only embodiments of this disclosure, and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

I/we claim:

1. A method for presenting information, comprising:
presenting an object information set in a predetermined page, wherein the object information set comprises object information of at least one predetermined object; and
in response to an interactive operation based on the predetermined page satisfying a predetermined condition, presenting a first component in the predetermined page, wherein the first component comprises resource information of a predetermined virtual resource, the first component is configured to trigger acquisition of the predetermined virtual resource, and the predetermined virtual resource is configured to complete a predetermined interactive event for the predetermined object.

2. The method of claim 1, wherein presenting the first component in the predetermined page in response to the interactive operation based on the predetermined page satisfying the predetermined condition comprises at least one of the following:
in response to a predetermined trigger for object information of a target predetermined object among the at least one predetermined object, presenting a target page, in response to a page return operation based on the target page, presenting the predetermined page, and presenting the first component in the predetermined page, wherein the target page is configured to present object detail information of the target predetermined object;
in response to an accumulated number of pieces of object information presented in the predetermined page responding to the interactive operation for the object information set being greater than or equal to a predetermined number threshold, presenting the first component in the predetermined page; or
in response to a number of times of a search operation triggered based on the predetermined page being greater than or equal to a predetermined times threshold, presenting the first component in the predetermined page, wherein a search result of the search operation comprises the object information set.

3. The method of claim 2, wherein presenting the predetermined page and presenting the first component in the predetermined page comprises:
presenting the predetermined page, and presenting the first component in an area adjacent to a presenting area of the predetermined page where the object information of the target predetermined object is located.

4. The method of claim 1, wherein presenting the first component in the predetermined page comprises:
in response to existence of a predetermined virtual resource to be acquired, presenting the first component in the predetermined page.

5. The method of claim 1, wherein the first component further comprises a first control; and the method further comprises: after presenting the first component in the predetermined page,
in response to a trigger for the first control,
canceling presenting of the first component, and
presenting a second component in the predetermined page, wherein the first component is configured to trigger acquisition of the predetermined virtual resource, and the second component comprises predetermined prompt information configured to prompt to use of the predetermined virtual resource.

6. The method of claim 5, wherein the predetermined prompt information comprises a second control; and the method further comprises: after presenting the second component in the predetermined page,
in response to a trigger for the second control, presenting resource detail information of the predetermined virtual resource.

7. The method of claim 5, wherein the second component satisfies at least one of the following:
the second component being a floating component;
a presenting size of the second component being smaller than a presenting size of the first component; or
a presenting position of the second component being different from a presenting position of the first component.

8. The method of claim 1, wherein the method further comprises:
before presenting the object information set in the predetermined page, acquiring object search information; and
wherein presenting the object information set in the predetermined page comprises:
in response to a search operation triggered for the object search information, presenting the object information set in the predetermined page, wherein the at least one predetermined object is associated with the object search information.

9. An electronic device, comprising:
one or more processors; and
a storage device configured to store one or more programs;
wherein the one or more programs, when executed by the one or more processors, cause the one or more processors to perform acts comprising:
presenting an object information set in a predetermined page, wherein the object information set comprises object information of at least one predetermined object; and
in response to an interactive operation based on the predetermined page satisfying a predetermined condition, presenting a first component in the predetermined page, wherein the first component comprises resource information of a predetermined virtual resource, the first component is configured to trigger acquisition of the predetermined virtual resource, and the predetermined virtual resource is configured to complete a predetermined interactive event for the predetermined object.

10. The electronic device of claim 9, wherein presenting the first component in the predetermined page in response to the interactive operation based on the predetermined page satisfying the predetermined condition comprises at least one of the following:
in response to a predetermined trigger for object information of a target predetermined object, presenting a target page, in response to a page return operation based on the target page, presenting the predetermined page, and presenting the first component in the predetermined page, wherein the target page is configured to present object detail information of the target predetermined object, and the target predetermined object is one of the at least one predetermined object;
in response to an accumulated number of pieces of object information presented in the predetermined page responding to the interactive operation for the object information set being greater than or equal to a predetermined number threshold, presenting the first component in the predetermined page; or
in response to a number of times of a search operation triggered based on the predetermined page being greater than or equal to a predetermined times threshold, presenting the first component in the predetermined page, wherein a search result of the search operation comprises the object information set.

11. The electronic device of claim 10, wherein presenting the predetermined page and presenting the first component in the predetermined page comprises:
presenting the predetermined page, and presenting the first component in an area adjacent to a presenting area of the predetermined page where the object information of the target predetermined object is located.

12. The electronic device of claim 9, wherein presenting the first component in the predetermined page comprises:
in response to existence of a predetermined virtual resource to be acquired, presenting the first component in the predetermined page.

13. The electronic device of claim 9, wherein the first component further comprises a first control; and the acts further comprise: after presenting the first component in the predetermined page,
in response to a trigger for the first control,
canceling presenting of the first component, and
presenting a second component in the predetermined page, wherein the first component is configured to trigger acquisition of the predetermined virtual resource, and the second component comprises predetermined prompt information configured to prompt to use of the predetermined virtual resource.

14. The electronic device of claim 13, wherein the predetermined prompt information comprises a second control; and the acts further comprise: after presenting the second component in the predetermined page,
in response to a trigger for the second control, presenting resource detail information of the predetermined virtual resource.

15. The electronic device of claim 14, wherein the second component satisfies at least one of the following:
the second component being a floating component;
a presenting size of the second component being smaller than a presenting size of the first component; or
a presenting position of the second component being different from a presenting position of the first component.

16. The electronic device of claim 9, wherein the acts further comprise:
before presenting the object information set in the predetermined page, acquiring object search information; and
wherein presenting the object information set in the predetermined page comprises:
in response to a search operation triggered for the object search information, presenting the object information set in the predetermined page, wherein, the at least one predetermined object is associated with the object search information.

17. A non-transitory computer storage medium comprising computer-executable instructions, wherein the computer-executable instructions, when executed by a computer processor, cause the process to implement acts comprising:
presenting an object information set in a predetermined page, wherein the object information set comprises object information of at least one predetermined object; and
in response to an interactive operation based on the predetermined page satisfying a predetermined condition, presenting a first component in the predetermined page, wherein the first component comprises resource information of a predetermined virtual resource, the first component is configured to trigger acquisition of the predetermined virtual resource, and the predetermined virtual resource is configured to complete a predetermined interactive event for the predetermined object.

18. The non-transitory computer storage medium of claim 17, wherein presenting the first component in the predetermined page in response to the interactive operation based on the predetermined page satisfying the predetermined condition comprises at least one of the following:
in response to a predetermined trigger for object information of a target predetermined object, presenting a target page, in response to a page return operation based on the target page, presenting the predetermined page, and presenting the first component in the predetermined page, wherein the target page is configured to present object detail information of the target predetermined object, and the target predetermined object is one of the at least one predetermined object;
in response to an accumulated number of pieces of object information presented in the predetermined page responding to the interactive operation for the object information set being greater than or equal to a predetermined number threshold, presenting the first component in the predetermined page; or
in response to a number of times of a search operation triggered based on the predetermined page being greater than or equal to a predetermined times threshold, presenting the first component in the predetermined page, wherein a search result of the search operation comprises the object information set.

19. The non-transitory computer storage medium of claim 18, wherein presenting the predetermined page and presenting the first component in the predetermined page comprises:
presenting the predetermined page, and presenting the first component in an area adjacent to a presenting area of the predetermined page where the object information of the target predetermined object is located.

20. The non-transitory computer storage medium of claim 18, wherein presenting the first component in the predetermined page comprises:
in response to existence of a predetermined virtual resource to be acquired, presenting the first component in the predetermined page.
